(19) United States
(12) Patent Application Publication
(10) Pub. No.: US 2025/0121822 A1
(43) Pub. Date: Apr. 17, 2025

(54) COLLISION AVOIDANCE ASSIST DEVICE

(71) Applicant: Hitachi Astemo, Ltd., Hitachinaka-shi, Ibaraki (JP)

(72) Inventors: Akinori KAMIYA, Tokyo (JP); Satoshi KASHIWAMURA, Tokyo (JP)

(73) Assignee: Hitachi Astemo, Ltd., Hitachinaka-shi, Ibaraki (JP)

(21) Appl. No.: 18/834,652

(22) PCT Filed: Aug. 24, 2022
(86) PCT No.: PCT/JP2022/031834

§ 371 Date: Jul. 31, 2024

(30) Foreign Application Priority Data
Feb. 15, 2022 (JP) 2022-021522

(51) Int. Cl. B60W 30/095; G01S 13/931; G01S 17/931; G06V 20/58

(52) U.S. Cl. CPC B60W 30/0956; G01S 13/931; G01S 17/931; G06V 20/58; B60W 2420/403; B60W 2420/408; B60W 2554/4041; B60W 2556/20

(57) ABSTRACT

Provided is a collision avoidance assist device including an algorithm for adjusting a balance between prevention of the excessive operation and prevention of the non-operation. A recognition sensor 106, a first collision estimation unit 131 and a second collision estimation unit 132 having different characteristics (response characteristics), the first collision estimation unit 131 having higher responsiveness than the second collision estimation unit 132, and the second collision estimation unit 132 having higher noise resistance than the first collision estimation unit 131, a first collision risk level calculation unit 141 that calculates a first collision risk level based on a first estimation result, a second collision risk level calculation unit 142 that calculates a second collision risk level based on a second estimation result, and collision estimation arbitration unit 150, 250 that selects either the first estimation result or the second estimation result.

### TECHNICAL FIELD

The present invention relates to a collision avoidance assist device that assists collision avoidance between a mobile object and a target.

### BACKGROUND ART

As a conventional technique of a collision avoidance assist device that assists collision avoidance between a mobile object (host vehicle) and a target around the mobile object, the technique described in PTL 1 calculates the velocity/position of the target by an optical flow, and then determines whether the mobile object and the target collide with each other. The velocity/position calculation method of a target includes a processing method of searching for a corresponding point from image data.

### CITATION LIST

### Patent Literature

PTL 1: JP 2012-160128 A

### SUMMARY OF INVENTION

### Technical Problem

However, in the optical flow, since the collision estimation is performed by the relative velocity between the host vehicle and the target, the relative velocity is affected by the behavior component of the host vehicle, noise of the sensor itself, a sudden direction change of the target, and the like, and it is difficult to determine and separate which frequency component is the frequency component used in the control, and the collision prediction accuracy is lowered.

The decrease in the collision prediction accuracy includes a decrease in sensor accuracy of a recognition sensor, a decrease in accuracy due to driver operation, a situation of the host vehicle, and a vehicle parameter identification error. The decrease in accuracy due to the driver's operation means that the driver's operation change affects the future host vehicle position when the future host vehicle position is predicted assuming that the current driver's operation continues. The situation of the host vehicle is a case where acceleration or vibration is applied to the host vehicle resulting in pitching and rolling. The vehicle parameter identification error is a case where physical values such as a center of gravity and a weight necessary for estimating a future position of the host vehicle are different from actual values. In such a case, the accuracy of the prediction position of the host vehicle decreases, and thus the collision prediction accuracy decreases.

The following two events are conceivable in a case where the collision determination accuracy decreases.

The excessive operation is an operation where it is determined that the host vehicle and the target have collided with each other due to a decrease in collision prediction accuracy even though the host vehicle and the target are in the positional relationship so as not to collide with each other, and the collision avoidance assist device operates.

The non-operation is an operation where it is determined that there is no collision due to a decrease in the collision prediction accuracy regardless of the positional relationship in which the host vehicle collides with the target, and the collision avoidance assist device does not operate.

There is a contradictory relationship between the prevention of the excessive operation and the non-operation, and it is difficult to completely achieve both the prevention of the excessive operation and the prevention of the non-operation.

Since the collision avoidance assist device is a device that assists the driving operation by the driver, there is a tendency that the non-operation is allowable but the excessive operation is not allowable in the non-operation and the excessive operation. This is because even when the driver is driving carefully, the control is excessively performed to hinder the driving operation by the driver, and in addition, since the sudden control intervention may cause secondary damage, in the collision avoidance assist device, it is more important to place a higher priority on the prevention of the excessive operation than the prevention of the non-operation.

In order to cope with such a problem, in the present invention, it is conceivable to provide a technique for improving the collision prediction accuracy (solving the problem of lowering the collision prediction accuracy) by removing noise from each of the host vehicle velocity and the target velocity and reducing the risk of occurrence of the excessive operation. However, placing excessive priority on the prevention of the excessive operation at this time makes it difficult to realize the prevention of the non-operation.

The present invention has been made in view of the above circumstances, and an object of the present invention is to provide a collision avoidance assist device including an algorithm for adjusting a balance between prevention of the excessive operation and prevention of the non-operation.

### Solution to Problem

In order to solve the above problem, a collision avoidance assist device according to the present invention is mounted on a mobile object and avoids a collision between the mobile object and a target around the mobile object, the collision avoidance assist device including a recognition sensor that acquires information about a position and a velocity of the target, a first collision estimation unit and a second collision estimation unit that output an estimation result regarding a collision between the mobile object and the target using the information acquired by the recognition sensor as an input and have different characteristics, the first collision estimation unit having higher responsiveness than the second collision estimation unit, the second collision estimation unit having higher noise resistance than the first collision estimation unit, a first collision risk level calculation unit that calculates a first collision risk level based on a first estimation result output by the first collision estimation unit, a second collision risk level calculation unit that calculates a second collision risk level based on a second estimation result output by the second collision estimation unit, and a collision estimation arbitration unit that selects either the first estimation result or the second estimation result.

### Advantageous Effects of Invention

According to the present invention, it is possible to balance prevention of the excessive operation and prevention of the non-operation even in a turning motion of the host vehicle, for example, and to support collision avoidance.

Problems, configurations, and effects other than those described above will be clarified by the following description of embodiments.

### BRIEF DESCRIPTION OF DRAWINGS

FIG. 1 is a first scene example in which the excessive operation occurs.

FIG. 2 is a second scene example in which the excessive operation occurs.

FIG. 3 is a control block diagram of the collision avoidance assist device according to the first embodiment.

FIG. 4 is an explanatory diagram of definition of coordinates.

FIG. 5 is an explanatory diagram of a collision risk level.

FIG. 6 is an explanatory diagram of an arbitration logic of a collision estimation arbitration unit of an estimation result of the first embodiment.

FIG. 7 is a flowchart of the collision estimation arbitration unit of the first embodiment.

FIG. 8 is a first scene example using the first embodiment.

FIG. 9 is a second scene example using the first embodiment.

FIG. 10 is a third scene example using the first embodiment.

FIG. 11 is a control block diagram of a collision avoidance assist device according to the second embodiment.

FIG. 12 an explanatory diagram of a weight of collision prediction accuracy.

FIG. 13 is an explanatory diagram of an arbitration logic of a collision estimation arbitration unit of an estimation result of the second embodiment.

FIG. 14 is a flowchart of the collision estimation arbitration unit of the second embodiment.

FIG. 15 is the third scene example using the second embodiment.

### DESCRIPTION OF EMBODIMENTS

In the present invention, an estimation result of a target and a host vehicle which is a mobile object is output from a sensor input signal. The present invention relates to a collision avoidance assist device equipped with this vehicle control.

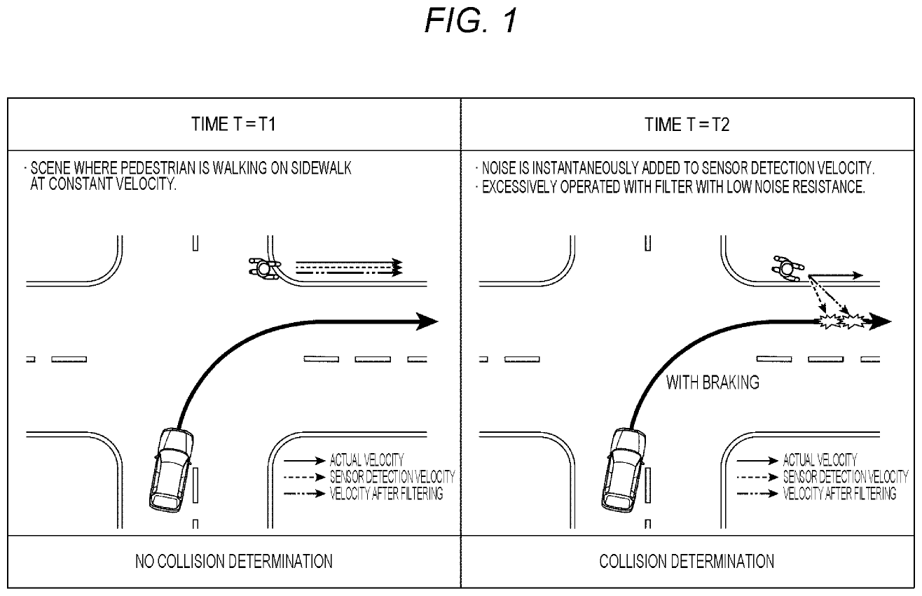

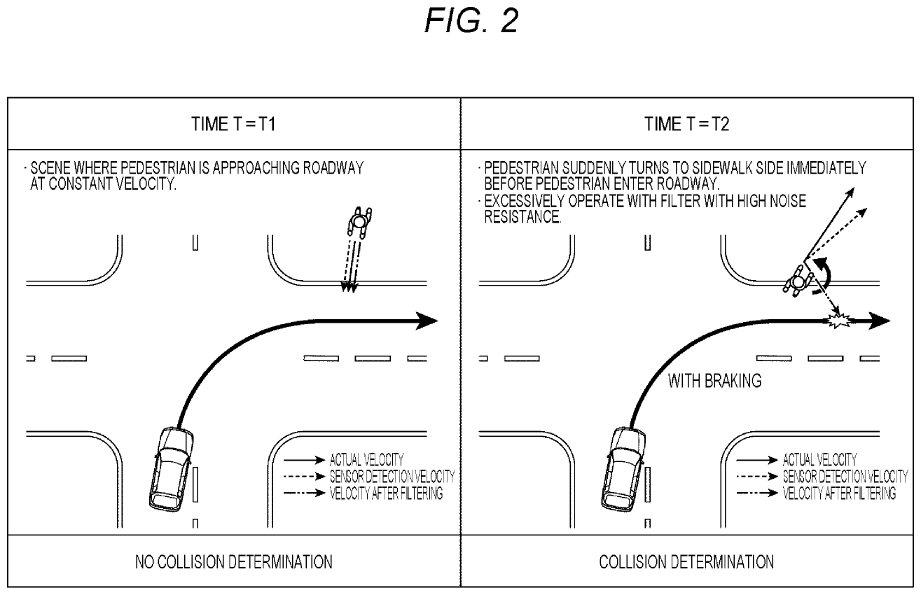

Prior to description of a specific embodiment of the present invention, specific examples of a scene where the excessive operation occurs are shown in FIGS. 1 and 2.

FIG. 1 is an excessive determination scene assuming that the movement velocity information about the pedestrian momentarily indicates an abnormal value due to sensor noise. At time T=T1, a pedestrian is walking on a sidewalk at a constant velocity, and the host vehicle starts turning at an intersection. At the time T=T2, the pedestrian actually walks on the sidewalk where the pedestrian does not collide with the host vehicle, but the movement velocity information (sensor detection velocity) about the pedestrian momentarily indicates an abnormal value due to the sensor noise, so that it may be erroneously determined that the pedestrian is moving in the direction across the intersection.

In general, when a sensor detection value is used for control, noise removal is performed in order to suppress the influence of electromagnetic noise from the sensor itself, the communication path, the connector, and the outside. A low-pass filter (low-pass filter) is often used for noise removal.

In a case where noise is removed by a filter or the like having low noise resistance (in other words, responsiveness is high), in the velocity/position detection result of the target from the recognition sensor, as indicated by the velocity vector of the sensor detection velocity in FIG. 1, it is excessively determined that there is a collision between the host vehicle and the target, and there is a possibility that, for example, an action of collision avoidance such as automatic braking is erroneously performed. The collision avoidance action may be a warning sound, vibration, a warning light, or automatic steering.

FIG. 2 is an excessive determination scene assuming a case where the target moves rapidly. At time T=T1, a pedestrian is walking toward a roadway on a sidewalk at a constant velocity, and the host vehicle starts turning at an intersection. When both continue the current operation, they collide. However, at time T=T2, the pedestrian turned in the opposite direction immediately before entering the roadway. In this case, in the velocity/position detection result of the target from the recognition sensor, when noise is removal by a low-response (in other words, high noise resistance) filter or the like, a following delay occurs in the velocity vector of the sensor detection velocity with respect to the actual velocity, and it is excessively determined that there is a collision between the host vehicle and the target, and for example, an action of collision avoidance such as automatic braking is erroneously performed.

From the above two excessive operation scenes, it is difficult to suppress the excessive operation while suppressing the non-operation only by gain adjustment such as a single velocity filter.

Hereinafter, embodiments of the present invention will be described with reference to the drawings.

### First Embodiment

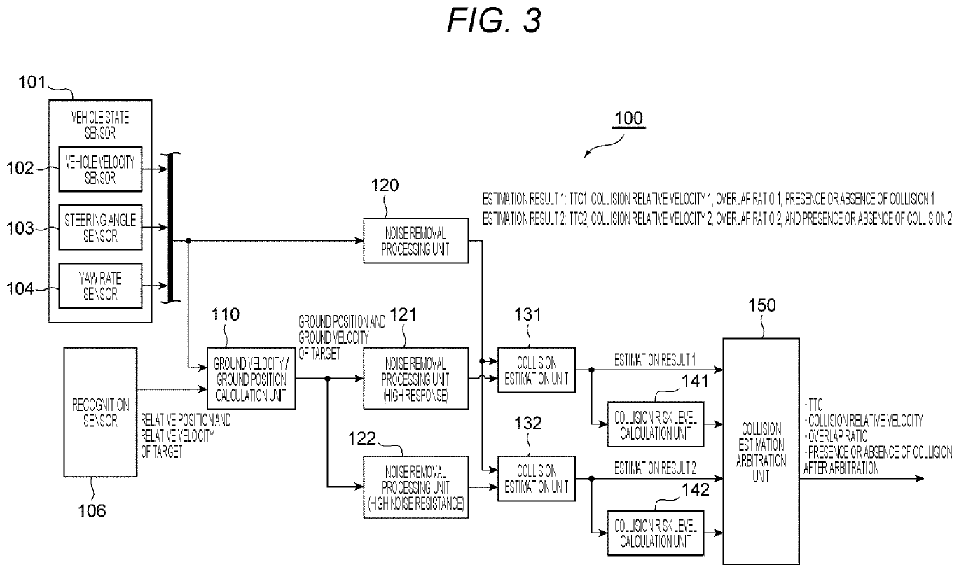

The first embodiment is a mode for preventing the excessive operation while preventing the non-operation. FIG. 3 illustrates a control block configuration of the collision avoidance assist device according to the first embodiment.

A collision avoidance assist device 100 of the first embodiment is a device that is mounted on a vehicle (host vehicle) and avoids a collision between the vehicle (host vehicle) and a target around the vehicle (host vehicle). The collision avoidance assist device 100 includes a vehicle state sensor 101 and recognition sensor 106.

The vehicle state sensor 101 is a sensor that acquires information (vehicle state information) regarding the vehicle state of the host vehicle. The vehicle state sensor 101 includes a vehicle velocity sensor 102 that acquires a velocity of the host vehicle, a steering angle sensor 103 that acquires a steering angle of the host vehicle, a yaw rate sensor 104 that acquires a yaw rate of the host vehicle, and the like.

The recognition sensor 106 is a sensor that recognizes the surrounding environment of the host vehicle. The recognition sensor 106 includes a camera, a millimeter wave radar, a laser radar, and the like mounted on the host vehicle. In this example, the recognition sensor 106 acquires information about a relative position and a relative velocity of a target around the host vehicle.

As illustrated in FIG. 3, the collision avoidance assist device 100 includes, as functional blocks, a ground velocity/ground position calculation unit 110, noise removal processing units 120, 121, and 122, collision estimation units 131 and 132, collision risk level calculation units 141 and 142, and a collision estimation arbitration unit 150.

The ground velocity/ground position calculation unit 110 calculates the ground position and the ground velocity of the target based on the vehicle state information acquired by the vehicle state sensor 101 and the information about the relative position and the relative velocity of the target acquired by the recognition sensor 106.

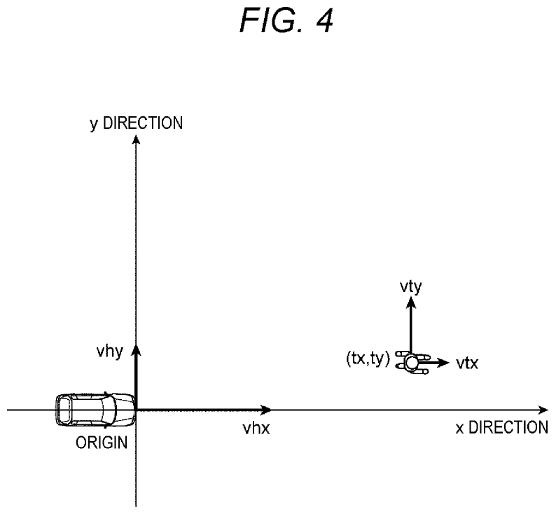

FIG. 4 illustrates a definition of coordinate axes. The coordinate axes represent that the x axis indicates the front-rear direction of the host vehicle, and the y axis indicates the left-right direction of the host vehicle with the bumper of the host vehicle as a reference origin. At this time, the ground velocity [m/s] (vtx, vty) of the target is calculated by the following Equation (1) from the relative velocity [m/s] (vtx′, vty′) of the target obtained from the recognition sensor information, the velocity [m/s] (vhx, why) of the host vehicle obtained from the vehicle velocity sensor and the yaw rate sensor, and the peripheral velocity component [m/s] (−γ·yt, γ·xt) when the yaw rate [rad/s] of the host vehicle is γ.

$$\begin{matrix}[ Math 1 ] & \\ ( \begin{matrix}vtx \\ vty\end{matrix} ) = ( \begin{matrix}{vtx}^{′} \\ {vty}^{′}\end{matrix} ) + ( \begin{matrix}vhx \\ vhy\end{matrix} ) - γ ( \begin{matrix}- yt \\ xt\end{matrix} ) & Equation ( 1 )\end{matrix}$$

On the other hand, in the conversion of the ground position (tx, ty) of the target, when the coordinate axes are defined as illustrated in FIG. 4, the relative position (tx′, ty′) of the target obtained from the recognition sensor information and the ground position (tx, ty) are equal.

The host vehicle cannot make a sudden direction change at a high speed, but a target such as a pedestrian can make a rapid direction change at a low speed, so that the operation frequency domains are different from each other. Therefore, as illustrated in FIG. 3, noise removal processing blocks for the host vehicle and a target (such as a pedestrian) are separately provided.

A noise removal processing unit 120, which is a noise removal processing block of the host vehicle, performs noise removal processing of the velocity/position of the host vehicle obtained from the vehicle state information using, for example, a low-pass filter (low-pass filter).

The noise removal processing block of the target is provided with a plurality of blocks so as to follow the high-response operation of the target and remove radio frequency noise. In the example of FIG. 3, a noise removal processing unit 121 that is a highly responsive noise removal processing block capable of following even a sudden movement of a target, and a noise removal processing unit 122 that is a highly noise resistance noise removal processing block robust to instantaneous noise are provided.

The velocity/position of the target calculated by the ground velocity/ground position calculation unit 110 is input to the noise removal processing unit 121 and the noise removal processing unit 122. The noise removal processing unit 121 performs a high-response noise removal process on the velocity/position of the target, and the noise removal processing unit 122 performs a high-noise resistance noise removal process on the velocity/position of the target.

The velocity/position of the host vehicle that is noise removal processed by the noise removal processing unit 120 and the velocity/position of the target that is noise removal processed by the high-response noise removal processing unit 121 are input to the collision estimation unit 131 which is a collision estimation block. The velocity/position of the host vehicle that is noise removal processed by the noise removal processing unit 120 and the velocity/position of the target that is noise removal processed by the high-noise resistance noise removal processing unit 122 are input to the collision estimation unit 132 which is a collision estimation block. The collision estimation units 131 and 132 perform collision estimation between the host vehicle and the target from the input information. The collision estimation unit 131 has higher responsiveness than the collision estimation unit 132 by using information that is high-response noise removal processed, and the collision estimation unit 132 has higher noise resistance than the collision estimation unit 131 by using information that is high-noise resistance noise removal processed, and both have different response characteristics.

The collision estimation units 131 and 132 predict the future position of the host vehicle on the assumption that the host vehicle turns with a constant radius from the steering angle and the speed of the host vehicle that is noise removal processed, for example. Similarly, the collision estimation units predict the future position of the target on the assumption that the target moves at a constant velocity from the target velocity and the target position that is noise removal processed. Then, a collision between the host vehicle and the target is estimated from the future position of the host vehicle and the future position of the target.

As the estimation result regarding the collision, the time until the collision between the host vehicle and the target (hereinafter, described as Timeto Collision (TTC)), the relative velocity in the front-rear direction between the host vehicle and the target (hereinafter, described as a collision relative velocity) at the time of collision (at the collision prediction point), the ratio of the overlap between the host vehicle range and the target range (hereinafter, described as an overlap ratio) at the time of collision (at the collision prediction point), and the presence or absence of collision are output.

From this estimation result, collision risk level calculation units 141 and 142, which are collision risk level calculation blocks, respectively calculate collision risk level. That is, the estimation result 1 of the highly responsive collision estimation unit 131 is input to the collision risk level calculation unit 141, and the collision risk level calculation unit 141 calculates a collision risk level 1 based on the estimation result 1. Similarly, the estimation result 2 of the collision estimation unit 132 having high noise resistance is input to the collision risk level calculation unit 142, and the collision risk level calculation unit 142 calculates a collision risk level 2 based on the estimation result 2.

Regarding the collision risk level, the accuracy of a collision prediction, the magnitude of damage, and the degree of urgency (margin) to collision are expressed by one scale as the collision risk level of the following Equation (2), and the collision risk level can be grasped by one parameter.

$$\begin{matrix}[ Math 2 ] & \\ collision risk level = ( accuracy of a collision prediction ) \times ( magnitude of damage ) \times ( degree of urgency to collision ) & Equation ( 2 )\end{matrix}$$

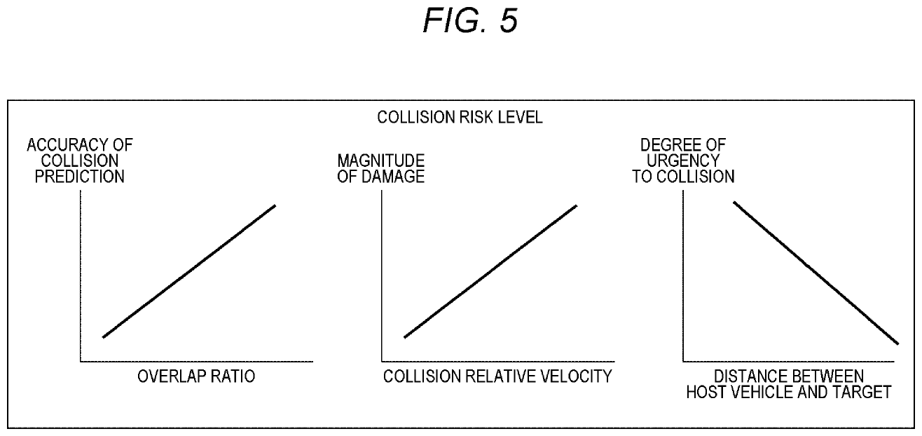

Here, the accuracy of the collision prediction is determined according to the overlap ratio (FIG. 5), the magnitude of the damage is determined according to the collision relative velocity (FIG. 5), and the urgency to collision is determined according to the distance between the host vehicle and the target (calculated corresponding to the TTC) (FIG. 5).

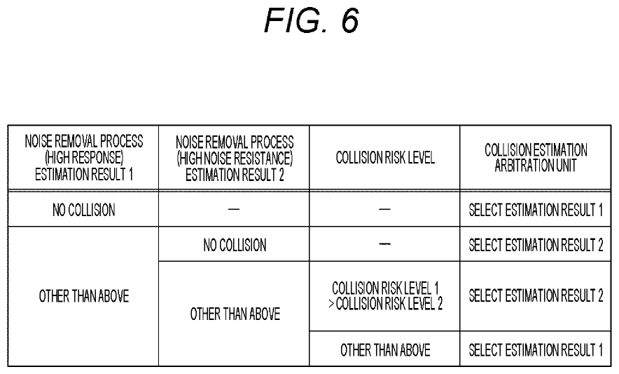

Then, from the collision risk level and the estimation result, the collision estimation arbitration unit 150 which is the collision estimation arbitration block determines which one of results 1 and 2 of the presence or absence of the collision of the estimation result is selected. In other words, the collision estimation arbitration unit 150 arbitrates the collision result from the estimation results 1 and 2 and the magnitude of the collision risk levels 1 and 2. An arbitration logic of the collision estimation arbitration unit 150 is illustrated in FIG. 6.

When either of the estimation results 1 and 2 is determined as no collision, the collision estimation arbitration unit 150 determines that there is no collision. In addition, when it is determined that both of the estimation results 1 and 2 indicate a collision, the collision estimation arbitration unit 150 selects a reliable collision risk level indicating both of the estimation results. That is, in the case described in the left, a collision result (estimation result corresponding to low collision risk level by comparing collision risk level 1 and collision risk level 2) having a low collision risk level is selected.

In this manner, as in the logic of the collision estimation arbitration unit 150 of FIG. 6, the collision is redundantly determined, and the estimation result is arbitrated using the collision risk level when both of them have the risk of collision, whereby the excessive operation can be prevented.

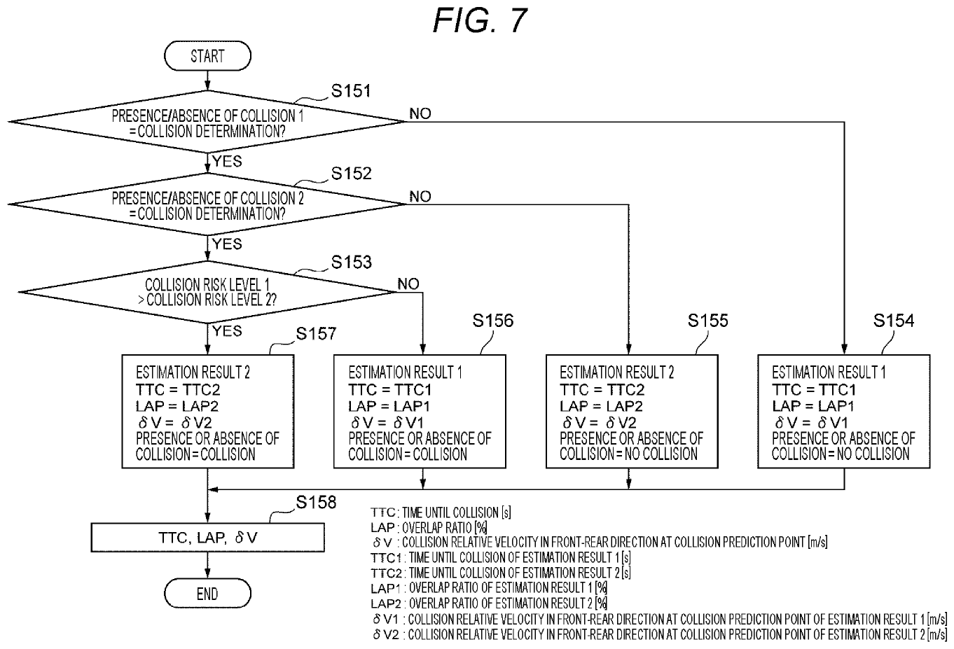

FIG. 7 is a flowchart illustrating the collision estimation arbitration unit 150 of the first embodiment. As described above, when there is no collision determination in the presence or absence of collision 1 or 2 (of the estimation result 1 or 2), that is, when “No” is obtained in S151 or S152 in the flowchart, the estimation result determined as no collision is selected (S154, S155). Similarly, when there is collision determination in the presence or absence of collision 1 and 2 (of the estimation results 1 and 2), that is, when “Yes” is obtained in S151 and S152 in the flowchart, the collision risk level 1 and 2 are compared (S153), and an estimation result with a smaller collision risk level is selected (S156, S157). Then, the selected estimation result (TTC: Time until a collision, LAP: overlap ratio, dV: collision relative velocity) is externally output for use in braking control or the like (S158).

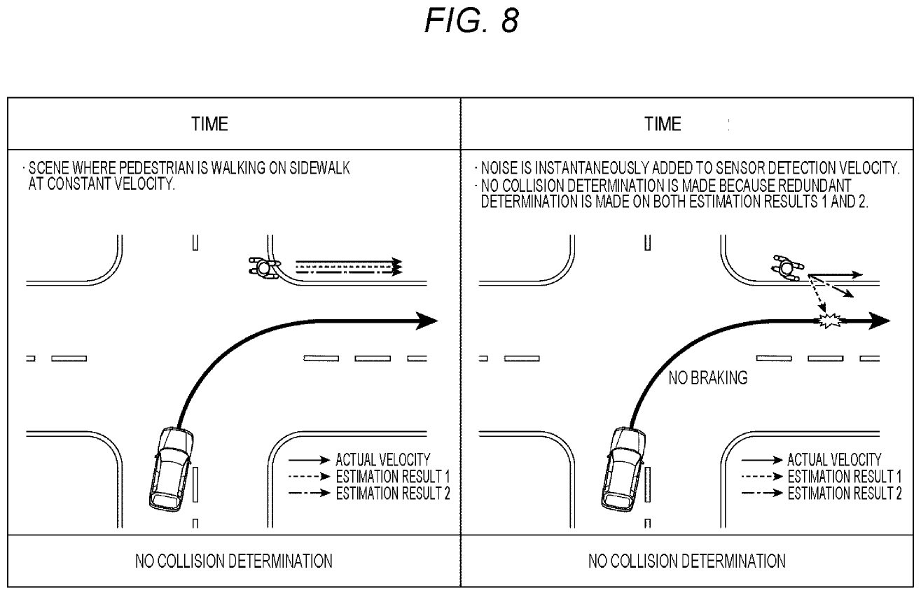

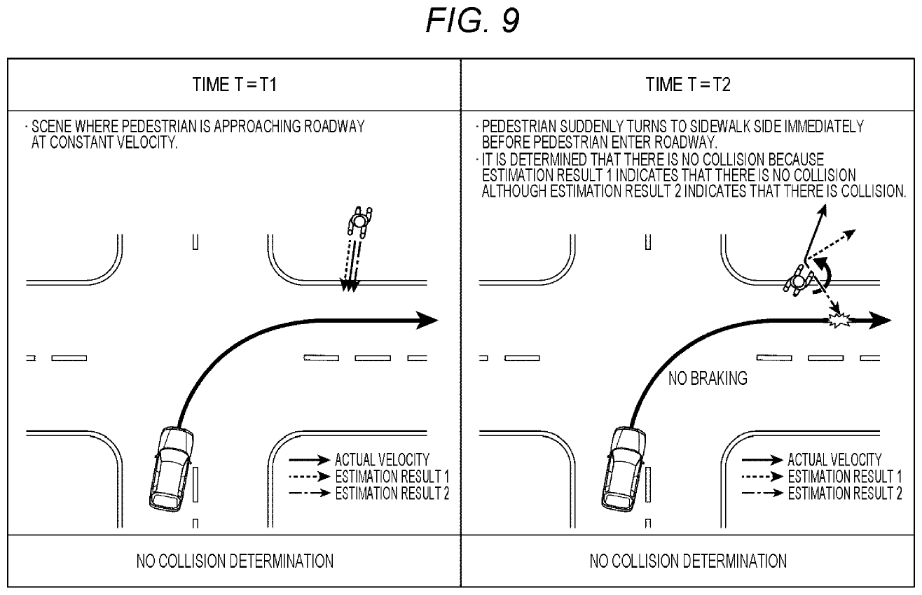

FIGS. 8 and 9 illustrate a case where the first embodiment is used for the scenes of FIGS. 1 and 2.

In FIG. 8, in a case where instantaneous noise is included in the sensor detection velocity, in the estimation result 1, the followability to the noise is high because of a high response, so that it is determined that there is a collision, but, in the estimation result 2, the followability to the actual velocity is low because of noise immunity (high noise resistance), so that it is determined that there is no collision. From the logic of the collision estimation arbitration unit 150, when any one of the estimation results 1 and 2 indicates no collision, the arbitration result can be correctly determined as no collision. Therefore, it is possible to prevent the collision avoidance action from being erroneously performed.

In FIG. 9, with respect to a sudden direction change of a target such as a pedestrian, it is determined that there is no collision due to a high response in the estimation result 1, but it is determined that there is a collision due to noise immunity (high noise resistance) in the estimation result 2. From the logic of the collision estimation arbitration unit 150, when any one of the estimation results 1 and 2 indicates no collision, the arbitration result can be correctly determined as no collision. Therefore, it is possible to prevent the collision avoidance action from being erroneously performed.

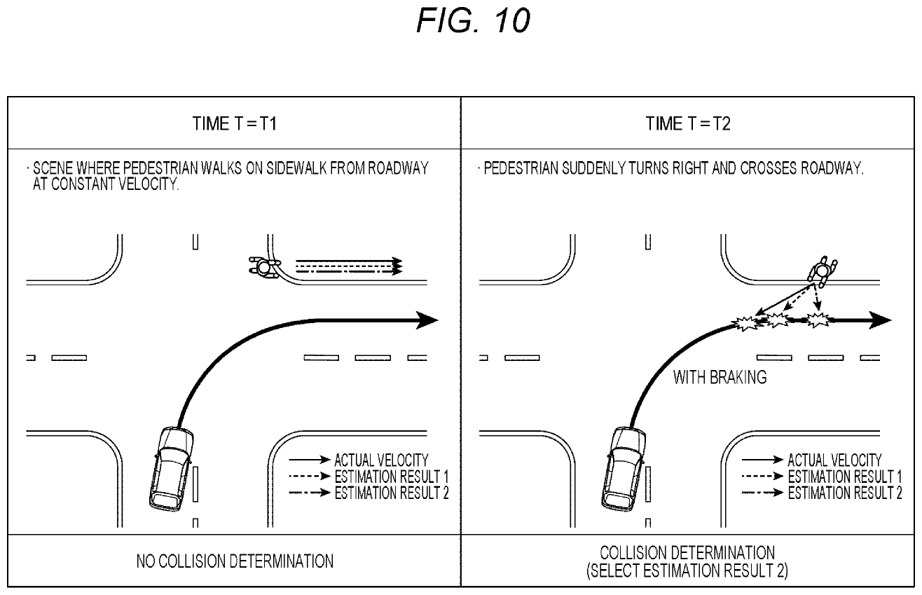

In FIG. 10, a scene different from those in FIGS. 8 and 9 is added. This is a scene in which a pedestrian who is walking on a sidewalk suddenly changes direction, enters a crosswalk and crosses a roadway, and a collision is predicted. In this scene, both the estimation result 1 and the estimation result 2 predict a collision (it is determined that there is a collision), and the estimation result 2 having a low collision risk is selected by the collision estimation arbitration unit 150. Therefore, in this case, the collision avoidance action can be performed.

As described above, according to the first embodiment, it is possible to prevent the non-operation while suppressing the excessive operation.

### Second Embodiment

In the first embodiment, the non-operation can be prevented while suppressing the excessive operation, but since the priority is fixed to the prevention of the excessive operation in the prevention of the excessive operation and the prevention of the non-operation rather than, the timing of the braking by the collision avoidance assist device 100 is delayed. Specifically, in the scene of FIG. 10, there is a problem in that the collision determination position of the estimation result 2 is far from the actual collision position, and a position farther than the actual collision point is determined as the collision point. In the second embodiment, in order to solve the problem of the first embodiment, an algorithm for automatically adjusting the balance between the prevention of the excessive operation and the prevention of the non-operation is shown.

In addition to the configuration of the first embodiment, in the second embodiment, the weight of the collision prediction accuracy corresponding to the certainty of the collision prediction is defined according to the travel environment and the sensing environment, and an algorithm for changing the arbitration method of the estimation result 1 and the estimation result 2 according to the magnitude of the weight of the collision prediction accuracy is added to the first embodiment.

The collision prediction accuracy is affected by the travel environment and the sensing environment. When the travel environment and the sensing environment are good, the weight of the collision prediction accuracy is increased in order to select the estimation result (estimation result with high collision risk level) with which collision can be avoided earlier and start braking, and when the travel environment and the sensing environment deteriorate, the weight of the collision prediction accuracy is decreased in order to select the more reliable estimation result (estimation result with low collision risk level) and perform braking.

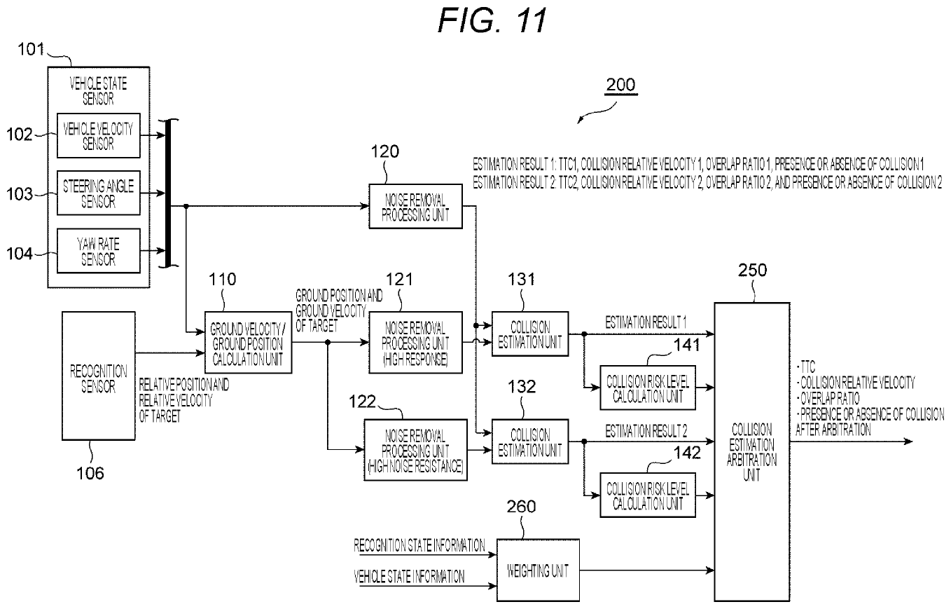

FIG. 11 is a control block diagram of the collision avoidance assist device according to the second embodiment. A collision avoidance assist device 200 of the second embodiment is different from that of the first embodiment in that it includes a weighting unit 260. In the example illustrated in FIG. 11, the weighting unit 260 calculates (the magnitude of) the weight of the collision prediction accuracy based on the vehicle state information obtained from the vehicle state sensor 101 and the recognition state information obtained from the recognition sensor 106. The weighting unit 260 inputs the weight to a collision estimation arbitration unit 250, and the collision estimation arbitration unit 250 arbitrates the collision result according to the weight.

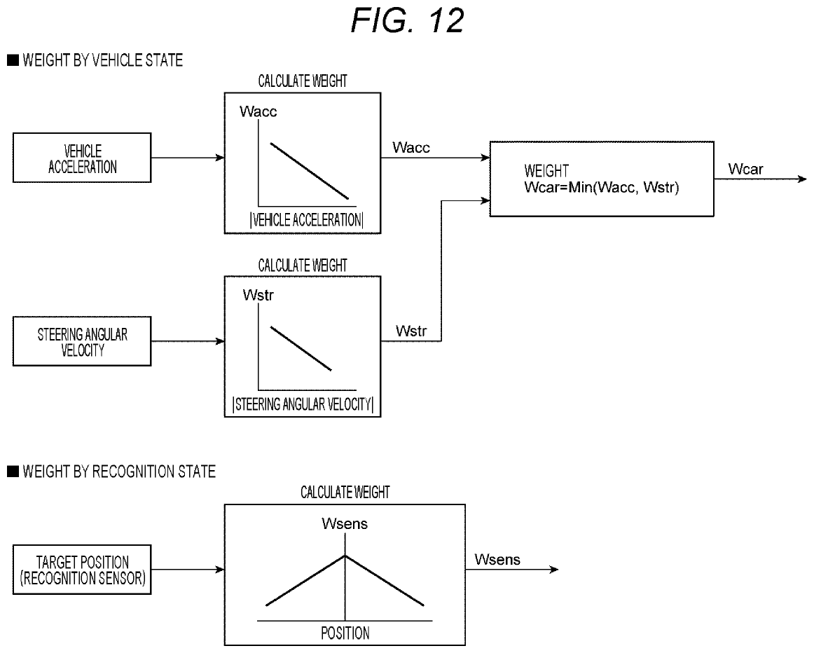

As illustrated in FIG. 12, the weight includes, for example, a weight Wcar according to a vehicle state and a weight Wsens according to a recognition state. For example, in order to lower the risk of the excessive operation, for the weight Wcar according to the vehicle state, the smaller one of a weight Wacc according to the vehicle acceleration and a weight Wstr according to the steering angular velocity is selected. When the vehicle acceleration and the steering angular velocity increase, the vehicle state greatly fluctuates, and it is difficult to predict the future host vehicle position, so that Wacc and Wstr are reduced. As illustrated in FIG. 12, Wacc and Wstr are extracted from the map. In addition, for the weight Wsens according to the recognition state, for example, the central field of view has the highest recognition accuracy and the peripheral field of view has the lower recognition accuracy due to the directivity of the radar and the principle of camera parallax of the stereo camera, and thus, the weight Wsens is set to be the largest at an angle of view of 0° with respect to the target position, and to decrease the weight Wsens as the distance from 0° increases. Wsens is extracted from the map as illustrated in FIG. 12. The weight W is normalized to 1 when the travel environment and the sensing environment are the best and 0 when the travel environment and the sensing environment are the worst.

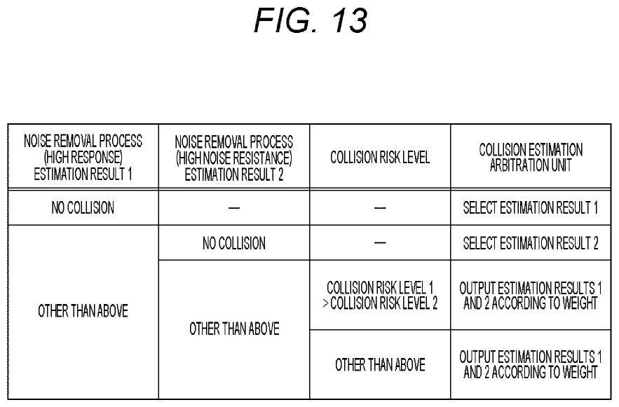

An arbitration logic of the collision estimation arbitration unit 250 of the second embodiment is illustrated in FIG. 13.

As in the collision estimation arbitration unit 150 of the first embodiment, the collision estimation arbitration unit 250 determines that there is no collision when there is no collision in either of the estimation results 1 and 2. When both of the estimation results 1 and 2 indicate a collision, the collision estimation arbitration unit 250 can output the estimation result 1 and the estimation result 2 according to the weight.

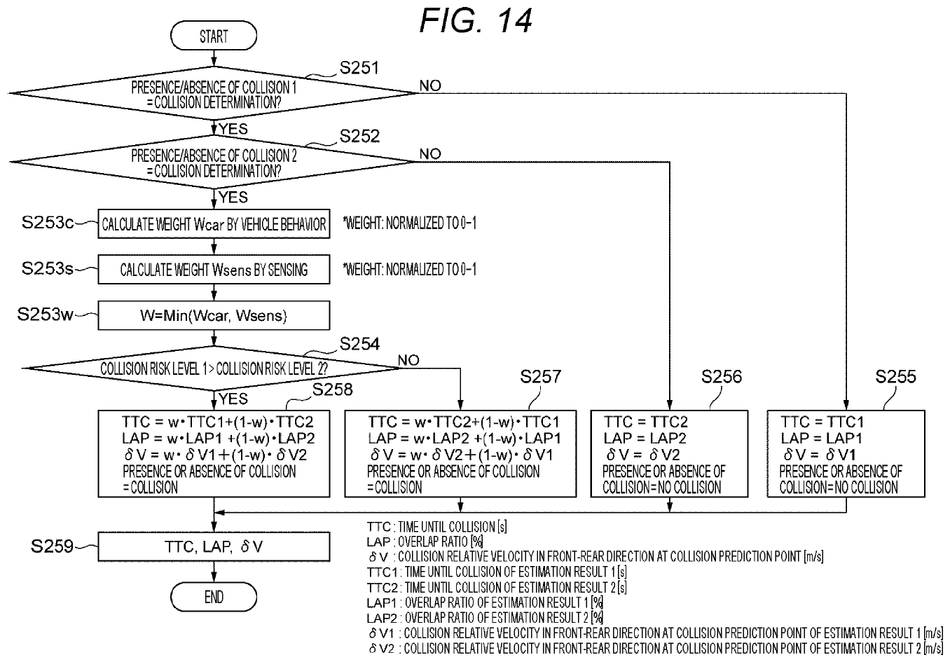

FIG. 14 is a flowchart illustrating the collision estimation arbitration unit 250 of the second embodiment. As described above, when there is no collision determination in the presence or absence of collision 1 or 2 (of the estimation result 1 or 2), that is, when “No” is obtained in S251 or S252 in the flowchart, the estimation result determined as no collision is selected (S255, S256). Similarly, when there is collision determination in the presence or absence of collision 1 and 2 (of the estimation results 1 and 2), that is, when “Yes” is obtained in S251 and S252 in the flowchart, the weight Wcar by vehicle behavior and the weight Wsens by sensing are calculated (S253c, S253s). In order to reduce the risk of the excessive operation, the smaller one of the two weights of the weight Wcar by vehicle behavior and the weight Wsens by sensing is selected to calculate the final weight W (S253w). With the weight W, the weight W is added to the estimation result and the weighted result is output.

For example, the collision risk levels 1 and 2 are compared (S254), and in a case where the collision risk level 1 by the high-response noise removal process (noise removal processing unit 121) is larger than the collision risk level 2 by the high-noise resistance noise removal process (noise removal processing unit 122), when W=1, the sensing environment is the best, so that the estimation result 1 having a high collision risk level (corresponding to the collision risk level 1) is output (TTC=TTC1, LAP=LAP1, δV=δV1), and when W=0, the sensing environment is the worst, so that the estimation result 2 having a low collision risk level (corresponding to the collision risk level 2) is output (TTC=TTC2, LAP=LAP2, δV=δV2) (S258). Furthermore, the estimation result 1 and the estimation result 2 can be arbitrated by determining the distribution of the estimation result 1 and the estimation result 2 by the magnitude of the weight W, specifically, such that the distribution of the estimation result 1 having a high collision risk level (corresponding to the collision risk level 1) is larger and the distribution of the estimation result 2 having a low collision risk level (corresponding to the collision risk level 2) is smaller as W is larger (approaches 1), or such that the distribution of the estimation result 1 having a high collision risk level (corresponding to the collision risk level 1) is smaller and the distribution of the estimation result 2 having a low collision risk level (corresponding to the collision risk level 2) is larger as W is smaller (approaches 0), and the estimation result according to the sensing environment can be output (S258).

Similarly, in a case where the collision risk level 1 is smaller than the collision risk level 2 (the collision risk level 2 is larger than the collision risk level 1), when W=1, the sensing environment is the best, so that the estimation result 2 having a high collision risk level (corresponding to the collision risk level 2) is output (TTC=TTC2, LAP=LAP2, δV=δV2), and when W=0, the sensing environment is the worst, so that the estimation result 1 having a low collision risk level (corresponding to the collision risk level 1) is output (TTC=TTC1, LAP=LAP1, δV=>δV1) (S257). Furthermore, the estimation result 1 and the estimation result 2 can be arbitrated by determining the distribution of the estimation result 1 and the estimation result 2 by the magnitude of the weight W, specifically, such that the distribution of the estimation result 2 having a high collision risk level (corresponding to the collision risk level 2) is larger and the distribution of the estimation result 1 having a low collision risk level (corresponding to the collision risk level 1) is smaller as W is larger (approaches 1), or such that the distribution of the estimation result 2 having a high collision risk level (corresponding to the collision risk level 2) is smaller and the distribution of the estimation result 1 having a low collision risk level (corresponding to the collision risk level 1) is larger as W is smaller (approaches 0), and the estimation result according to the sensing environment can be output (S257).

Then, the calculated estimation result (TTC: Time until a collision, LAP: overlap ratio, dV: collision relative velocity) is externally output for use in braking control or the like (S259).

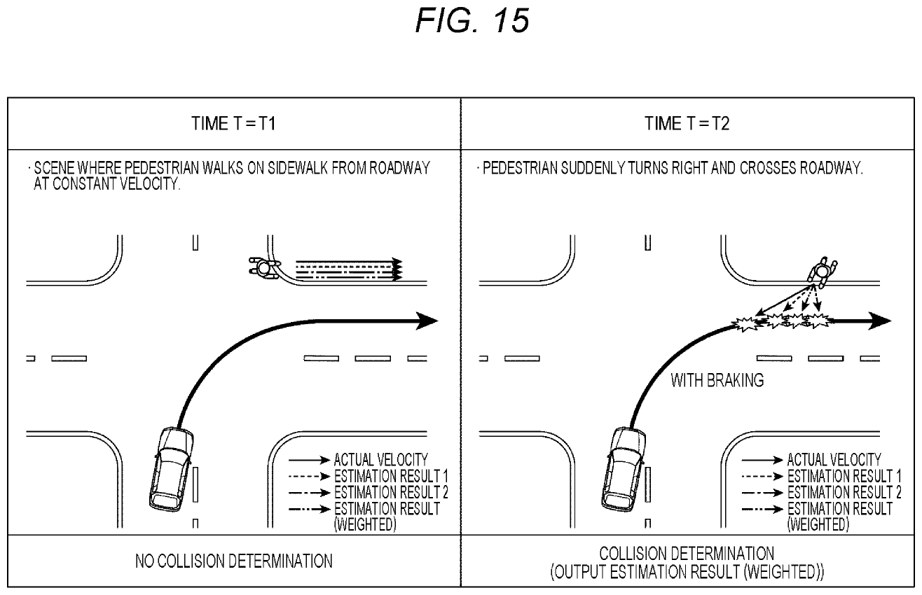

FIG. 15 is the same scene as FIG. 10. By selecting the estimation result (weighted) of the second embodiment, the braking by the collision avoidance assist device 200 can be operated at a more appropriate timing within a range in which the excessive operation does not occur. That is, when the accuracy of the collision determination is increased by determining the situation where the accuracy of the collision determination is increased, the braking operation can be performed earlier than the timing of the first embodiment set from the viewpoint of preventing the excessive operation, so that the collision avoidance performance can be enhanced while suppressing the risk of the excessive operation.

### Summary of First and Second Embodiments

As described above, the collision avoidance assist device 100, 200 according to the first and second embodiments is mounted on a mobile object and avoids a collision between the mobile object and a target around the mobile object, the collision avoidance assist device includes a recognition sensor 106 that acquires information about a position and a velocity of the target, a first collision estimation unit 131 and a second collision estimation unit 132 that output an estimation result regarding a collision between the mobile object and the target using the information acquired by the recognition sensor 106 as an input and have different characteristics (response characteristics), the first collision estimation unit 131 having higher responsiveness than the second collision estimation unit 132, the second collision estimation unit 132 having higher noise resistance than the first collision estimation unit 131, a first collision risk level calculation unit 141 that calculates a first collision risk level based on a first estimation result output by the first collision estimation unit 131, a second collision risk level calculation unit 142 that calculates a second collision risk level based on a second estimation result output by the second collision estimation unit 132, and a collision estimation arbitration unit 150, 250 that selects either the first estimation result or the second estimation result.

In addition, the first estimation result and the second estimation result includes at least one of a time until a collision, an overlap ratio that is a ratio at which a mobile object range and a target range overlap at a collision prediction point, and a relative velocity in a front-rear direction at the collision prediction point, wherein the first collision risk level calculation unit 141 and the second collision risk level calculation unit 142 calculate the first collision risk level and the second collision risk level from at least one of margin (degree of urgency) to collision, accuracy of a collision prediction with the target, and magnitude of damage, and wherein the collision estimation arbitration unit 150, 250 selects either the first estimation result or the second estimation result based on the first estimation result, the second estimation result, the first collision risk level, and the second collision risk level.

According to the first and second embodiments, it is possible to balance prevention of the excessive operation and prevention of the non-operation even in a turning motion of the host vehicle, for example, and to assist collision avoidance.

Note that the present invention is not limited to the above-described embodiments, and includes various modifications. For example, the above-described embodiments have been described in detail for easy understanding of the present invention, and are not necessarily limited to those having all the described configurations. Further, part of the configuration of one embodiment can be replaced with the configuration of another embodiment, and the configuration of another embodiment can be added to the configuration of one embodiment. In addition, it is possible to add, delete, and replace other configurations for part of the configuration of each embodiment.

In addition, some or all of the above-described configurations, functions, processing units, processing means, and the like may be realized by hardware, for example, by designing with an integrated circuit. In addition, each of the above-described configurations, functions, and the like may be realized by software by a processor interpreting and executing a program for realizing each function. Information such as a program, a table, and a file for realizing each function can be stored in a storage device such as a memory, a hard disk, and a solid state drive (SSD), or a recording medium such as an IC card, an SD card, and a DVD.

In addition, the control lines and the information lines indicate what is considered to be necessary for the description, and do not necessarily indicate all the control lines and the information lines on the product. In practice, it may be considered that almost all the configurations are connected to each other.

### REFERENCE SIGNS LIST

100 collision avoidance assist device (first embodiment)
101 vehicle state sensor (mobile object state sensor)
102 vehicle velocity sensor
103 steering angle sensor
104 yaw rate sensor
106 recognition sensor
110 ground velocity/ground position calculation unit
120 noise removal processing unit (host vehicle)
121 noise removal processing unit (high response) (target)
122 noise removal processing unit (high noise resistance) (target)
131 collision estimation unit (first collision estimation unit)
132 collision estimation unit (second collision estimation unit)
141 collision risk level calculation unit (first collision risk level calculation unit)
142 collision risk level calculation unit (second collision risk level calculation unit)
150 collision estimation arbitration unit
200 collision avoidance assist device (second embodiment)
250 collision estimation arbitration unit (second embodiment)
260 weighting unit (second embodiment)

1. A collision avoidance assist device that is mounted on a mobile object and avoids a collision between the mobile object and a target around the mobile object, the collision avoidance assist device comprising:
a recognition sensor that acquires information about a position and a velocity of the target;
a first collision estimation unit and a second collision estimation unit that output an estimation result regarding a collision between the mobile object and the target using the information acquired by the recognition sensor as an input and have different characteristics, the first collision estimation unit having higher responsiveness than the second collision estimation unit, the second collision estimation unit having higher noise resistance than the first collision estimation unit;
a first collision risk level calculation unit that calculates a first collision risk level based on a first estimation result output by the first collision estimation unit;
a second collision risk level calculation unit that calculates a second collision risk level based on a second estimation result output by the second collision estimation unit; and
a collision estimation arbitration unit that selects either the first estimation result or the second estimation result.

2. The collision avoidance assist device according to claim 1, wherein
the first estimation result and the second estimation result
include at least one of a time until a collision, an overlap ratio that is a ratio at which a mobile object range and a target range overlap at a collision prediction point, and a relative velocity in a front-rear direction at the collision prediction point, wherein
the first collision risk level calculation unit and the second collision risk level calculation unit
calculate the first collision risk level and the second collision risk level from at least one of a margin to a collision, accuracy of a collision prediction with the target, and magnitude of damage, and wherein
the collision estimation arbitration unit selects either the first estimation result or the second estimation result based on the first estimation result, the second estimation result, the first collision risk level, and the second collision risk level.

3. The collision avoidance assist device according to claim 1, wherein the collision estimation arbitration unit
determines that the mobile object and the target do not to collide with each other when either the first estimation result or the second estimation result indicates no collision, and
selects an estimation result corresponding to a low collision risk level by comparing the first collision risk level with the second collision risk level when both of the first estimation result and the second estimation result indicate a collision.

4. The collision avoidance assist device according to claim 1, wherein the collision estimation arbitration unit further selects the first estimation result or the second estimation result based on outputs by the recognition sensor and a mobile object state sensor that acquires a state of the mobile object.

5. The collision avoidance assist device according to claim 4, wherein the collision estimation arbitration unit arbitrates the first estimation result and the second estimation result according to a weight of collision prediction accuracy calculated based on outputs by the recognition sensor and the mobile object state sensor.

6. The collision avoidance assist device according to claim 4, wherein the collision estimation arbitration unit
increases a weight of collision prediction accuracy as a sensing environment obtained from an output by the recognition sensor or a travel environment obtained from an output by the mobile object state sensor improves,
when either the first estimation result of the second estimation result indicates no collision, determines that the mobile object and the target do not collide with each other, and
when both of the first estimation result and the second estimation result indicate a collision, arbitrates the first estimation result and the second estimation result such that as the sensing environment or the travel environment improves, an allocation of an estimation result corresponding to a high collision risk level is increased, and an allocation of an estimation result corresponding to a low collision risk level is decreased by comparing the first collision risk level with the second collision risk level, or as the sensing environment or the travel environment deteriorates, an allocation of an estimation result corresponding to a high collision risk level is decreased, and an allocation of an estimation result corresponding to a low collision risk level is increased by comparing the first collision risk level with the second collision risk level.
